(19) United States
(12) Patent Application Publication
(10) Pub. No.: US 2004/0070118 A1
(43) Pub. Date: Apr. 15, 2004

(54) Method for electrostatic spinning of polymers to obtain nanofibers and microfibers

(76) Inventor: Wolfgang Czado, Gefrees (DE)

Correspondence Address: FULBRIGHT & JAWORSKI, LLP, 1301 MCKINNEY, SUITE 5100, HOUSTON, TX, 77010-3095, US

(21) Appl. No.: 10/451,458

(22) PCT Filed: Dec. 20, 2001
(86) PCT No.: PCT/DE01/04804

(30) Foreign Application Priority Data
Dec. 20, 2000 (DE) 100 63 518.0

(51) Int. Cl. D06M 10/00; H05B 7/00

(52) U.S. Cl. 264/465

(57) ABSTRACT

Proposed is a method of electrostatic spinning of polymers to obtain nano- and microfibers wherein at least one substance which can be easily converted into the gaseous phase with an electronegativity>2 or increased molecular mass is added to a polymer solution or melt or is introduced into the space between the electrodes of a spinning apparatus, whereby ionisation of the process air, that is to say the air between the electrodes of the spinning apparatus, is reduced. In that way fibers of a smaller diameter can be obtained and can be spun from solutions of a lower polymer concentration.

The invention concerns a method of electrostatic spinning of polymers to obtain nano- and microfibers. In a method of that kind which is basically known from the state of the art a polymer in the form of a polymer melt or in the form of a solution is introduced into an electrical field and spun to form fibers by the action of the electrical field. In that case an electrode usually forms a receiving device for the spun fibers while the counterpart electrode is frequently designed in the form of an injection nozzle. The last-mentioned electrode however can also be in the form of a conveyor belt which can be heated and which can be charged up with a given potential in order to transfer solid polymers into a molten condition and to spin fibers from that melt.

Frequently with such a method the nano- and microfibers produced are not isolated but are deposited directly in the form of non-woven material. Mention may be made here for example of the production of filter media. Equally a spinning method of that kind produces shaped articles which for example are used in medicine as a substitute for blood vessels or other vessels.

In principle it is already known that the electrical forces which act are correspondingly greater, the higher the high voltage applied and the higher the electrical charge of the polymer fibers just as they issue. In that situation the polymer fiber becomes progressively thinner with the increase in the force acting thereon. Likewise the dimensions of the fibers produced or product properties such as for example the distribution of the fibers in a non-woven material depend on the geometry of the electrodes. That is also known and many different electrode shapes have therefore been provided.

It is found however that the state of the art suffers from the particular disadvantage that the diameter of the microfibers obtained with a method of electrostatic spinning of polymers is relatively thick and problems are involved in producing fibers of a comparatively small diameter. Furthermore the polymer throughput in the methods disclosed in the state of the art is relatively low so that increases are also desirable here.

Therefore the object of the present invention is at least to provide a further method of electrostatic spinning of polymers to obtain nano- and microfibers in order to at least partially overcome the disadvantages known from the state of the art.

The foregoing object is attained by a method of electrostatic spinning of polymers to obtain nano- and microfibers having the features of accompanying claim 1. Advantageous developments of the method of the invention are the subject-matter of claims 2 to 7.

In this respect the present invention is based on the realisation that the high voltage of the electrical field produced between the electrodes of the spinning apparatus also leads to ionisation of the air, which neutralises or reduces the charge in the fibers being sprayed off. That causes a reduction in the electrical force acting on the resulting fibers which therefore are no longer stretched to such a great degree. Fibers which are stretched to a lesser degree however are of a large fiber diameter than greatly stretched fibers. That relationship between energy introduced and energy effectively operative for the stretching action was previously not recognised.

There are basically various possible ways of achieving an improvement in the degree of stretching of the nano- and microfibers produced by electrostatic spinning.

Firstly in that respect consideration is to be given to the configuration of the electrodes. It is known in that respect from general physics that an electrical field is particularly strong at points or edges and correspondingly dense field lines occur in such regions. Such a strong field generally also results in increased air ionisation. For that reason it is certainly desirable for all edges of parts carrying high voltage or all edges of electrodes to be carefully rounded off in order to reduce air ionisation as much as possible. Specific production requirements however constitute a certain limit here as such requirements necessitate certain electrode shapes, such electrode shapes in part causing the above-mentioned phenomena of concentration of the field lines.

Another possible way would be an increased input of energy, that is to say for example an increase in the voltage between the electrodes, in which respect a corresponding air ionisation effect would be tolerated and it is assumed that at least a part of the energy additionally introduced into the system acts on the fibers as they are sprayed out and stretches them to a greater degree. It is thought however to be apparent to the man skilled in the art in this respect that the level of efficiency of this procedure is extremely poor as it is only ever the relatively small part of the additionally applied energy that affords a contribution to stretching of the polymer fibers. In accordance with the invention therefore there is proposed the addition of substances which reduce air ionisation insofar as they react with ionised air molecules or electrons and thus capture them. The ions which are freshly formed in that way are heavier and are therefore not accelerated so greatly in the electrical field. This means that they can also only poorly ionise further gas molecules so that the air ionisation effect decreases. In this respect basically all substances fall to be considered as electron acceptors, which can be easily transferred into a gaseous phase and which have at least one atom with an electronegativity>2 or which brake electrons by inelastic impacts to such an extent that further air ionisation is reduced or prevented. For the latter consideration is given in particular to substances with a molar mass which is increased in comparison with the molecules of the air.

Those substances can both be introduced into the process air, that is to say the air which fills and surrounds the electrode space of the spinning apparatus, or also directly into the melt or solution to be spun. Besides gases, also suitable for that purpose are liquid substances such as for example bromine or solid substances such as for example iodine which are added to the polymer solution or melt and which by virtue of their vapor pressure during the process at least partially pass into the gaseous phase and thereby reduce air ionisation.

It has been found that the at least one added substance is preferably selected from the halogens fluorine, chlorine, bromine, iodine and the compounds thereof with each other, halogen oxides such as for example Cl₂O, hydrogen halides, hydrogen fluoride, hydrogen chloride, hydrogen bromide and hydrogen iodide, which are present pure or in the form of aqueous solution, inert gas halides, nitrogen oxides such as for example nitrogen monoxide, dinitrogen monoxide and nitrogen dioxide, the sulfur oxides, sulfur monoxide, sulfur dioxide and sulfur trioxide, and sulfur hexafluoride.

Less effective although they can also be used are ammonia, inert gases, hydrogen, hydrogen sulfide, carbon monoxide, carbon dioxide and water. It is equally possible to use all substances which can break down to form the above-mentioned substances or liberate same by decomposition or reaction, such as for example NCl₃, NBr₃, NI₃, NOCl, NOBr, PCl₃, PBr₃, PI₃, PCl₅, PBr₅, SCl₂, S₂Cl₂, SCl₄, halides, oxohalides and sulfur halides of boron, silicon, germanium, tin, lead, nitrogen, phosphorus, arsenic, antimony, bismuth, sulfur, selenium and tellurium as well as halides and oxohalides of the transition elements such as for example titanium, vanadium, chromium and the like.

In a development of the method according to the invention the at least one substance which can be easily converted into the gaseous phase is added in an amount of between 0.5 and 50 g/l to the polymer solution or melt or is meteredly added to the process air in the space between the electrodes in such a way that an operating or working concentration of between 0.5 and 500 g/m³ results in that region and is maintained during implementation of the method.

As is set forth in still greater detail hereinafter, a relatively small addition already affords a surprisingly positive effect in terms of the reduction in fiber diameter and the increase in throughput capacity.

In a further advantageous embodiment of the method according to the invention at least the at least one gas is recovered from the process air and re-introduced into the method. It will be appreciated in that respect that it is appropriate also to recover solvent which is possibly contained in the process air and to return it to the processing cycle. That is appropriate not only for ecological reasons but also for economic reasons because considerable savings are to be achieved by virtue of re-using the stated substances.

Surprisingly it has also been found that the substances used which in part are highly aggressive substances do not detrimentally influence the properties of the nano- and microfibers produced with the method according to the invention, and already effectively contribute to reducing air ionisation, in unexpectedly low levels of concentration.

In this respect it is certainly to be assumed that the short contact time and the comparatively low concentration of such substances is crucial in that respect. All the more surprising in that respect however is the positive effect on the product of the method.

In principle the methods according to the invention can be used to spin all polymers which hitherto could already be processed with an electrostatic spinning method to constitute nano- and microfibers. In addition the method according to the invention first makes it possible to use given polymers or polymer solutions in an electrostatic spinning method. An example in this respect is polymethyl(meth)acrylate. That polymer is to be spun without any problems, with the method according to the invention.

It was hitherto also not possible to spin solutions of polystyrene, polycarbonate and polyacrylonitrile with levels of concentration relative to the total mass of the solution of below 30% by weight. With the method according to the invention however it is surprisingly possible also to spin solutions of those polymers with levels of concentration in the range of between 2 and 10% by weight and particularly preferably in the range of between 3 and 5% by weight.

Therefore, with the method according to the invention, preferably polyacrylonitrile, polyvinyl alcohol, polyamide, polystyrene, polycarbonate, polymethyl(meth)acrylate, polyethersulfone, polylactide, cellulose triacetate and/or polyvinyl chloride are spun individually or in combination of at least two of said polymers.

If spinning of the polymers takes place from a solution, the solvents used are preferably water, dichloromethane, dimethylformamide, formic acid, dimethylsulfoxide, toluene, chloroform, tetrahydrofuran, methylethylketone and/or diethylether, individually or in combination of at least two of said solvents.

The invention as described in general terms hereinbefore is discussed in greater detail hereinafter by means of an embodiment, this embodiment serving exclusively better to understand the invention and not to limit it.

Taking a solution which contains 5% by weight of polystyrene in dichloromethane and which cannot be electrostatically spun in a method in accordance with the state of the art as the solution only atomises to form drops and does not form fibers, chlorine gas is added thereto in an amount of between 0.5 and 50 g/l. With a voltage of between 15 and 50 kV fibers of a diameter of between 200 and 1500 nm are obtained, wherein the main proportion of the fibers is of a diameter of 600 nm. This is a marked improvement over the state of the art which admittedly mentions fiber diameters of up to 0.1 μm but cannot verify such small diameters.

A comparable result is obtained if the chlorine gas is contained in an amount of between about 0.5 and 500 g/m³ in the process air.

The throughput of polymer solution can also be increased approximately by a factor of 10. In tests on a laboratory apparatus in which the polymer solution is urged very slowly out of a 5 ml plunger syringe through a steel needle, a high voltage of about 30 kV is applied on the one hand at the steel needle and on the other hand at the counterpart electrode which is spaced at about 15 cm. If the flow rate is increased above 0.3 ml of polymer solution/hour without an addition according to the invention to the process air, most of the polymer solution simply drips off the needle, whereas with the addition of chlorine to the polymer solution as described above at least 3 ml of polymer solution/hour can be spun.

This embodiment therefore clearly demonstrates that the method according to the invention not only furnishes fibers with an improved stretching effect but at the same time results in an increase in the polymer throughput. Besides a qualitative improvement in the product this also permits an improved economic result in terms of carrying the method according to the invention into effect.

A further improvement in the result of the method can also be achieved by combination with other improvements in the method, such as for example the addition of agents for increasing the conductivity of the polymer solution or melt or the like.

1. A method of electrostatic spinning of polymers to obtain nano- and microfibers characterised in that at least one substance which can be easily converted into the gaseous phase with an electronegativity>2 is added to a polymer solution or melt or is introduced into the space between the electrodes of a spinning apparatus, wherein the at least one substance which can be easily converted into the gaseous phase is selected from the group which consists of halogens and compounds thereof with each other, halogen oxides, hydrogen halides, inert gas halides, nitrogen oxides, sulfur oxides, sulfur hexafluoride, ammonia, hydrogen, hydrogen sulfide, carbon monoxide, carbon dioxide, NCl₃, NBr₃, NI₃, NOCl, NOBr, PCl₃, PBr₃, PI₃, PCl₅, PBr₅, SCl₂, S₂Cl₂, SCl₄, halides, oxohalides and sulfur halides of boron, silicon, germanium, tin, lead, nitrogen, phosphorus, arsenic, antimony, bismuth, sulfur, selenium, and tellurium, halides and oxohalides of the transition elements titanium, vanadium and chromium and substances which break down to form same or liberate same by decomposition or reaction, and mixtures thereof.

2. A method as set forth in claim 1 characterised in that the at least one substance which can be easily converted into the gaseous phase is added to the polymer solution in an amount of between 0.5 and 50 g/l or meteredly added to the process air in the space between the electrodes in such a way that an operating or working concentration of between 0.5 and 500 g/m³ results.

3. A method as set forth in one of the preceding claims characterised in that the at least one substance which can be easily converted into the gaseous phase is recovered from the process air and reintroduced into the method.

4. A method as set forth in one of the preceding claims characterised in that polyacrylonitrile, polyvinyl alcohol, polyamide, polystyrene, polycarbonate, polymethyl(meth)acrylate, polyethersulfone, polylactide, cellulose triacetate and/or polyvinyl chloride is spun individually or in combination of at least two of said polymers.

5. A method as set forth in one of the preceding claims characterised in that the solvent used is water, dichloromethane, dimethylformamide, formic acid, dimethylsulfoxide, toluene, methylethylketone and/or diethylether individually or in combination of at least two of the aforementioned solvents.

6. A method as set forth in one of the preceding claims characterised in that the polymer concentration in the solution with respect to the total mass of the solution is a maximum of 30% by weight, in particular between 2 and 10% by weight and particularly preferably between 3 and 5% by weight.
